(19) United States
(12) Patent Application Publication
(10) Pub. No.: US 2010/0053634 A1
(43) Pub. Date: Mar. 4, 2010

(54) DIRECT SOLVE IMAGE BASED WAVE-FRONT SENSING

(75) Inventor: Richard G. Lyon, Marriottsville, MD (US)

Correspondence Address: NASA GODDARD SPACE FLIGHT CENTER, 8800 GREENBELT ROAD, MAIL CODE 140.1, GREENBELT, MD, 20771, US

(73) Assignee: NASA Headquarters, Washington, DC (US)

(21) Appl. No.: 12/198,466

(22) Filed: Aug. 26, 2008

(51) Int. Cl. G01B 11/02

(52) U.S. Cl. 356/508

(57) ABSTRACT

A method of aligning an array of mirrors and computer program product therefor. The method may be used to align mirrors in a sparse aperture telescope system, e.g., a spaced based imaging interferometer. An image projected onto mirrors in an array of mirrors is reflected onto a sensor, where a point spread function (PSF) is collected from a pair of mirrors. A spatial image is extracted from PSF sidebands and a difference (e.g., piston difference) is determined for the pair of mirrors from the spatial image. Tip and tilt are determined for the pair of mirrors from spatial image characteristics.

### RELATED CASES

This application is a continuation in-part application and claims the benefit of U.S. NonProvisional application Ser. No. 12/198,466, filed Aug. 26, 2008.

The invention described herein was made by an employee of the United States Government, and may be manufactured and used by or for the Government for governmental purposes without the payment of any royalties thereon or therefor.

### BACKGROUND OF THE INVENTION

1. Field of the Invention

The present invention is generally related to space-based imaging and more particularly to accurately sensing and controlling the wave-front in a space-based imaging interferometer.

2. Background Description

National Aeronautics and Space Administration (NASA) has been developing interferometric space-based imaging to realize future larger aperture science missions. Imaging interferometers contain an array of two (2) or more telescopes, or apertures, that coherently mix (interferometrically combine) images in a resultant high-resolution image, effectively synthesizing a single aperture. Misaligning the mirrors degrades the image wave-front, blurring or aberating images. Misalignment can even cause multiple images, with severe misalignment causing one per aperture or telescope.

Thus, the ability to sense and control the individual aperture misalignments is paramount to achieving high quality images. Typically, individual misalignments are quantified/encoded as what is known as wave-front error(s). The wave-front errors may be used as feedback control to adjust the mirror positions in what is known as wave-front control. Interferometric missions will require wave-front control onboard with the mirrors.

To that end the NASA Goddard Space Flight Center (NASA/GSFC) has developed the Fizeau Interferometry Testbed (FIT), to study wave-front sensing and control methodologies for future NASA interferometric missions, e.g., the Stellar Imager mission (hires.gsfc.nasa.gov/˜si). The FIT includes from 7-18 articulated mirrors (elements) in a non-redundant Golay pattern that focuses input light into an interferometric white light image. While coarse alignment, dithering combinations of mirrors to eliminate extra images for severe misalignment, may relatively straightforward; finer alignment necessary for high quality imaging requires accurate wave-front sensing and controlling each of the articulated mirrors. Even with such precise control, correctly aligning a number of articulated mirrors with each other can be a long, exhausting, iterative process. Previously, this was a computationally intensive process that required an unacceptably high number of iterations to converge.

Thus, there is a need for quick, compact wave-front sensing for efficiently aligning and controlling articulated mirrors in an array of mirrors in interferometric imaging systems.

### SUMMARY OF THE INVENTION

It is an aspect of the invention to quickly align articulated mirrors in an array of mirrors;

It is another aspect of the invention to facilitate wave-front sensing and control of articulated mirrors in an array of mirrors;

It is yet another aspect of the invention to minimize the wave-front sensing and control time required to align and simplify control of articulated mirrors in an array of mirrors used in an interferometric imaging system.

The present invention relates to a method of aligning an array of mirrors, apertures or telescopes, and computer program product therefor. The method may be used to align multiple apertures or telescopes in a sparse aperture telescope system, e.g., a spaced based imaging interferometer. The multiple apertures focus light from an external source, e.g. a star, to an image on a sensor. The focused light interferometrically combines all the light from the individual apertures to produce a spatial image. A local computer processes the spatial image, algorithmically, to extract the spatial frequency sidebands in pairwise fashion, where pairwise refers to interference from two separate apertures. Piston differences and tip and tilt sums result from this pairwise extraction, where the piston difference is the path length difference between 2 apertures and tip/tilt sums are the sum of the tip/tilts of the same pair of apertures. Since piston, tip and tilt quantify aperture position, wave-front error is linearly related to piston, tip and tilt. Thus, using linear algebraic techniques, each set of pairwise piston differences and tip and tilt sums translate into individual aperture piston, tip and tilt positions. Subsequently, individual aperture piston, tip and tilt positions are used to generate commands (feedback) to control the mirrors positions.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of application of the present invention in providing remote onboard wave-front sensing and control to quickly align before and, maintain alignment during, science observations and after array reconfigurations in the NASA SI;

FIG. 2 shows a schematic example of the NASA/GSFC Fizeau Interferometry Testbed (FIT) developed for studying wave-front sensing and control methodologies for SI;

FIG. 3 shows an example of a suitable method of wave-front sensing and control alignment;

FIG. 4 shows an example of steps in direct solve image-based wave-front sensing 140 according to a preferred embodiment of the present invention;

FIGS. 5A-E show pictorial examples of the steps in determining local piston differences;

FIGS. 6A-E show pictorial examples of those steps in determining tip and tilt sums;

FIG. 7A shows an example of constrained linear equations for converting piston differences (Δpᵢⱼ) to mirror pistons (pᵢ, pⱼ) for mirrors i and j;

FIG. 7 B shows a matrix solution example of the constrained piston differences, using a simple sparse matrix solution to converts from the direct solve phase retrieval piston differences to actual mirror piston per mirror.

### DESCRIPTION OF PREFERRED EMBODIMENTS

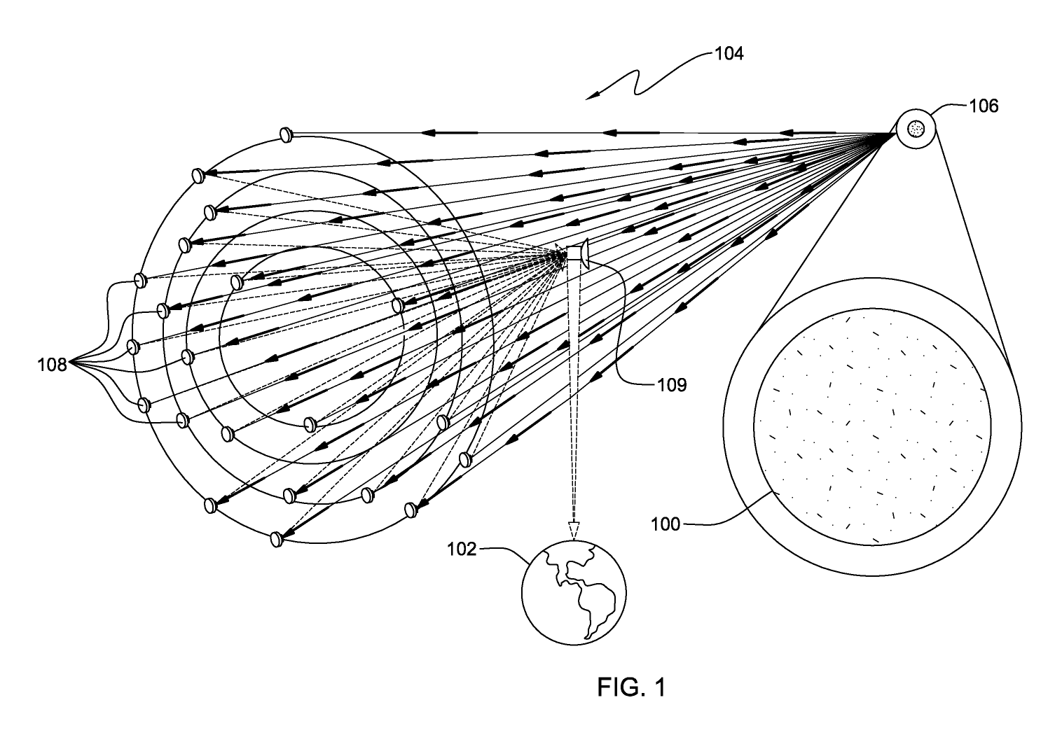

Turning now to the drawings and more particularly FIG. 1 shows an example of a National Aeronautics and Space Administration (NASA) space-based imaging interferometer, e.g., the NASA Stellar Imager (SI). In this example, application of the present invention provides remote onboard wave-front sensing and control to maintain aperture alignment during science observations and after array reconfigurations. SI is an ultraviolet (UV) optical interferometry mission in the NASA Sun-Earth 100, 102 connection, far-horizon roadmap. Such a mission requires both spatial and temporal resolution of stellar magnetic activity patterns 104, representing a broad range of activity level from stars 106. Studying these magnetic activity patterns 104 enables improved forecasting of solar/stellar magnetic activity as well as an improved understanding of the impact of that magnetic activity on planetary climate and astrobiology. SI, for example, may also allow for measuring internal structure and rotation of the stars 106 using the technique of asteroseismology and relating asteroseismology to the respective stellar dynamos 106.

SI may also image central stars in external solar systems (not shown) and enable an assessment of the impact of stellar activity on the habitability of the planets in those systems. Thus, SI may complement assessments of external solar systems that may be done by planet finding and imaging missions, such as the Space Interferometer Mission (SIM), Terrestrial Planet Finder (TPF) and Planet Imager (PI). SI employs a reconfigurable sparse array of 30 one-meter class spherical mirrors (e.g., 108) in a Fizeau mode, i.e., an image plane beam combination, with maximum baseline length up to ˜500 meters, yielding 435 independent spatial frequencies of the image. An earth orbit satellite or other vehicle 109 collects reflected image data and relays the collected information to earth 102.

Presently, imaging interferometry requires sensing path lengths to a fraction of the observing wavelength of light and controlling optical path lengths to a fraction of the coherence length, i.e., λ²/Δλ=λR. For example, λ=1550 Angstroms (1550 Å) at a spectral resolution R=100 implies sensing to λ/10=155 Å and effective control to <15.5 microns (15.5μ) in direct imaging mode provided tip/tilt per sub-aperture is corrected to better than 1.22λ/D=40 milli-arcseconds (mas) at the shortest wavelength. NASA Goddard Space Flight Center (NASA/GSFC) developed the Fizeau Interferometry Testbed (FIT) to study wave-front sensing and control methodologies for SI and other large, interferometric telescope systems.

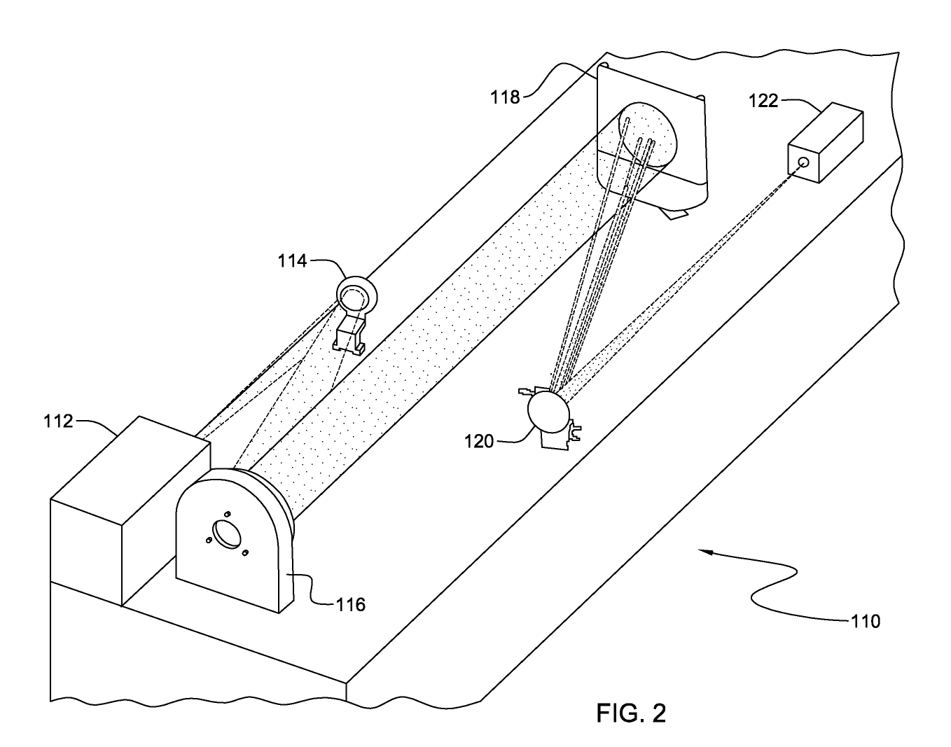

FIG. 2 shows a schematic example of the FIT 110, which includes in this example a light source 112 directing light at a hyperboloidal secondary mirror 114. The hyperboloidal secondary mirror 114 reflects and redirects the light to an off axis parabola (OAP) collimator 116 or OAP. Collimated light from the OAP 116 is directed to interferometric mirror array 118. Light reflected from the interferometric mirror array 118 is redirected by an elliptical secondary mirror 120 to focal 122, where the light from the individual mirrors 118 combine interferometrically into the resultant image.

Initially, FIT 110 was designed to operate at optical wavelengths using a minimum-redundancy array for segments of the primary mirror 118. Light from the source assembly 112 can illuminate an extended-scene film located in the front focal plane of the collimator mirror assembly, which includes the hyperboloid secondary mirror 114 and the off-axis paraboloid primary 116. The elements of the primary mirror array 118 are each positioned to intercept the collimated light, and relay it to the oblate ellipsoid secondary mirror 120, which subsequently focuses relayed light onto the image focal plane 122.

Previously, an optical trombone arrangement was used near the focal plane to allow 2 out-of-focus images to be simultaneously recorded on two CCD cameras for subsequent phase-diversity wave-front analysis in a typical state of the art computer. This optical trombone arrangement was proposed as a backup for the Hubble Space Telescope, and further, in diagnosing the initial problems with Hubble and estimating the quality of the fix. See, e.g., Grey et al., “Correction of Misalignment Dependent Aberrations of the Hubble Space Telescope,” Proc of SPIE 1168, August 1989; Lyon et. al, “Hubble Space Telescope Phase Retrieval: A Parameter Estimation,” Proc of SPIE 1567, July 1991; and Lyon, et. al., “Hubble Space Telescope Faint Object Camera Calculated Point Spread Functions,” Applied Optics, Vol. 36, No. 8, 1997. Moreover, the James Webb Space Telescope uses an optical trombone arrangement. See, e.g., Lyon et. al, “Extrapolating HST Lessions to NGST,” Optics and Photonics News, Vol 9, No 7, 1998.

Unfortunately, however, this optical trombone arrangement has proven highly inefficient for space based imaging interferometry. It requires splitting the light into two paths, which lowers the signal-to-noise ratio. Further, it requires two CCD cameras and introduces non-common path errors in the wave-front sensing. This is all beyond the computing power of state of the art computers that are compact and light enough for onboard computers. Thus, such an optical trombone arrangement makes implementing an interferometric space mission much more costly and complex.

By contrast a preferred embodiment direct solve approach directly addresses these problems, requiring only a single in-focus, but broadband image collected on a single CCD camera. A computer, which may or may not be the same computer, manipulates piezo actuators that control the aperture pistons positioning articulated primary mirror elements, and that control data acquisition by the CCD arrays mirror assembly, the hyperboloid secondary mirror 120 and OAP primary mirror 116 in the FIT 110. The primary mirror array 118 elements intercept the collimated light and relay it to the oblate ellipsoid secondary mirror 120, which finally focuses the collimated light onto the focal 122. The FIT 110 optics and mechanics are described in detail at hires.gsfc.nasa.gov/˜si and, moreover may be found in Richard G. Lyon et al., “Wave-front Sensing and Closed-Loop Control for the Fizeau Interferometry Testbed,” Proceedings of SPIE, Volume: 6687, 12 Sep. 2007, the contents of which are incorporated herein by reference.

As noted hereinabove, the distributed spacecraft in the NASA SI space-based ultraviolet (UV) imaging interferometer will require onboard wave-front sensing and control to maintain alignment during observations and after array reconfigurations. For example, an on-board flight processor may use images collected by a science camera located in the SI hub spacecraft (109 in FIG. 1). Thus to insure that this requirement is satisfied, FIT 110 is equipped with wave-front sensing and control according to a preferred embodiment of the present invention.

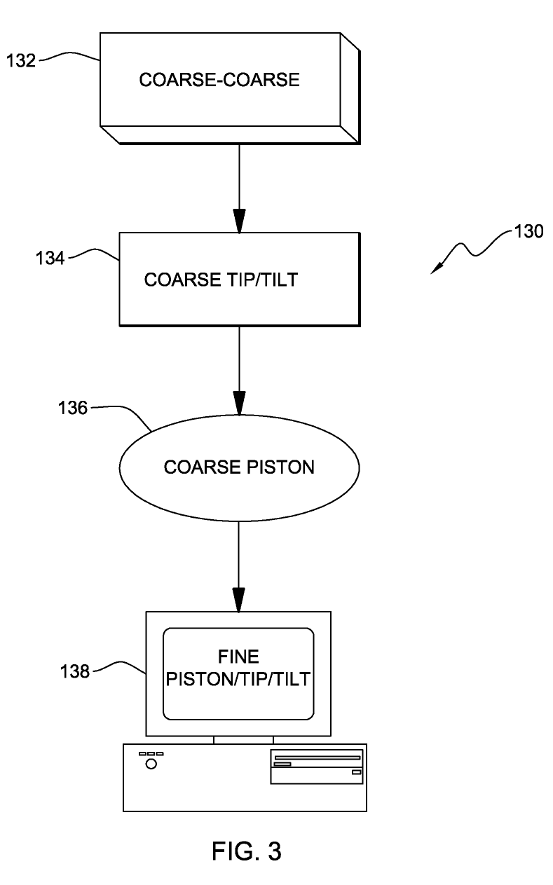

FIG. 3 shows an example of a suitable method of wave-front sensing and control alignment 130 according to a preferred embodiment of the present invention, e.g., as may be implemented in FIT 110 of FIG. 2. This preferred example includes four (4) primary stages Coarse-Coarse alignment/control 132, Coarse Tip/Tilt adjustment 134, Coarse Piston adjustment 136, and Fine Piston/Tip/Tilt adjustment 138 according to a preferred embodiment of the present invention.

Wave-front control 130 begins with Coarse-Coarse alignment/control 132, which occurs when the system 110 is initially turned on. The focal planes 122 collect a single white light image of an unresolved source. If the system 110 is unaligned a number of spots (primary beam images) appear in the focal plane 122 with each spot having a determinable flux. If the number of spots does not match the number of mirrors in the primary mirror array 118, then some may be overlapping and each spot is checked. If the number of spots are less than the number of mirrors, then each mirror is dithered. Dithering introduces tip and/or tilt into each of the mirrors. The tip/tilt is introduced in various different directions and by different amounts for each mirrorlet. Then, a new image is collected and compared to (differenced from) the preceding image. The differences identify which mirror corresponds to which spot.

Coarse Tip/Tilt adjustment 134 uses a sigma-centroid algorithm to find the centroid of all the spots and to crop the image acquisition region. By first locating the mean and the standard deviation of the entire image, the result may be pared to only those points that fall above the mean plus 1 sigma to determine the centroid, i.e. the flux weighted center of mass of the image. The image acquisition region is an area centered on the centroid. Again, the spots are matched with mirrors, this time using a smaller tip/tilt dither and a simple estimate of the mapping from actuator tip/tilt to motion of the spot on the CCD grid of focal planes 122. At this point the mirrors are coarse corrected for tip/tilt but, because of significant piston errors between the mirrors, have not been phased.

Coarse Piston adjustment 136 brings each of the baseline pairs piston difference to within a coherence length of each other. Coarse Piston adjustment 136 begins by first unstacking the images, i.e. moving all the mirrors such that the pattern of spots emulates the aperture pattern. Then, continuing by moving two of the mirrors in tip/tilt such that they overlap in the center of the image acquisition region and dithering the respective pistons (not shown) until interference starts to occur. This can be performed for each baseline pair sequentially or for two or more in parallel. Once Coarse Piston adjustment 136 is complete, all the mirrors have been tip/tilted to the center and partially piston corrected such that all piston errors are within ±0.61 λB/D. However, since the tip/tilt motion of the actuators is not totally separable from the piston motion, the mirrors are still only partially pistoned.

Fine Piston/Tip/Tilt adjustment (or fine phasing) 138 uses direct solve image-based wave-front sensing to determine local piston difference, tip and tilt sums for each baseline pair according to a preferred embodiment of the present invention. Generally, fine phasing 138 takes a more global approach using only a single white light in-focus point spread function, and simultaneously using all mirrors in the array 118 to solve for piston differences and tip/tilt sums on a per baseline pair basis and. Further, by collecting images from the focal planes 122 and solving for the optical wave-front, the collected wave-front is proportional to optical misalignments, design errors, fabrication errors and may be used as a diagnostic to assess the performance of the optical system. Unlike prior fine phasing approaches, direct solve image-based wave-front sensing provides a wave-front solution directly from a single image without defocussing and without resorting to nonlinear iterative algorithms.

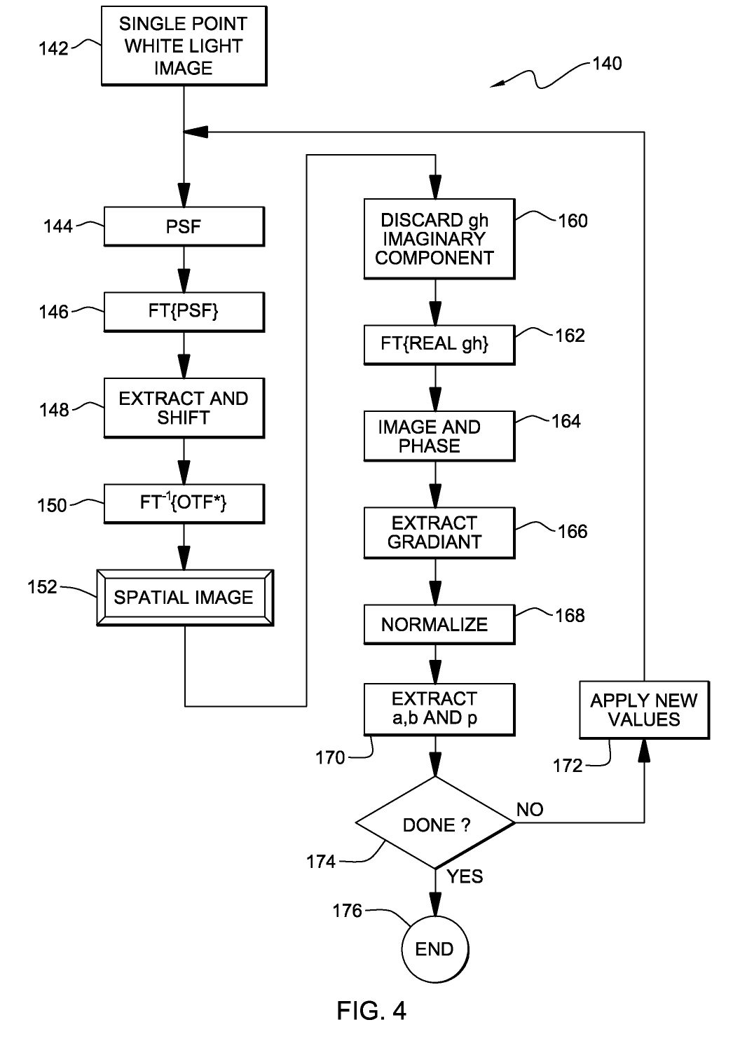

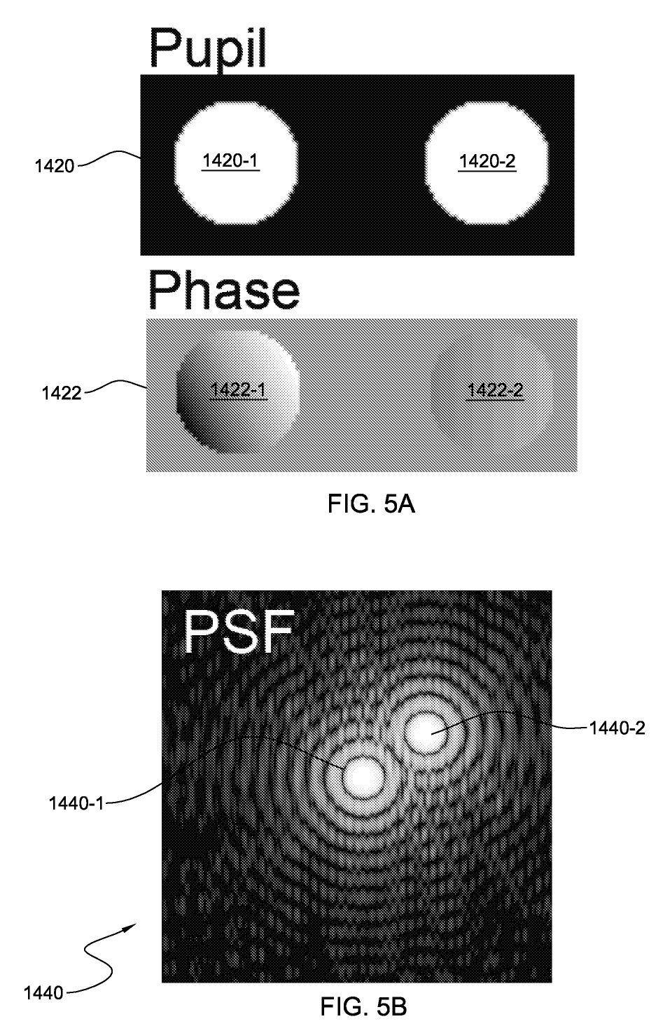

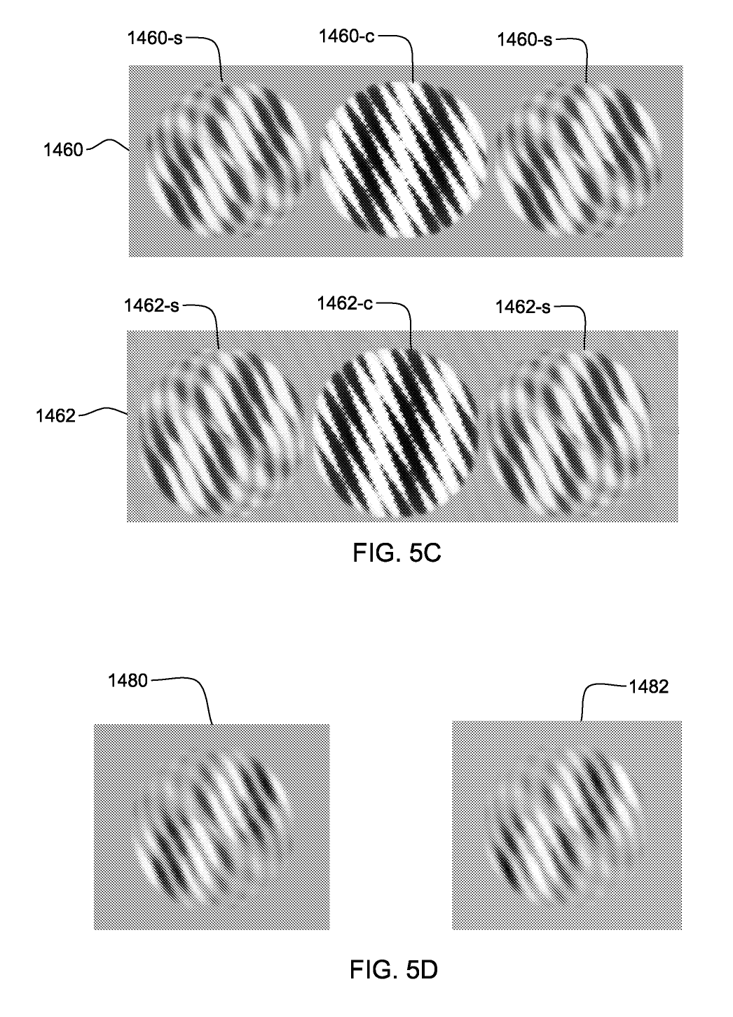

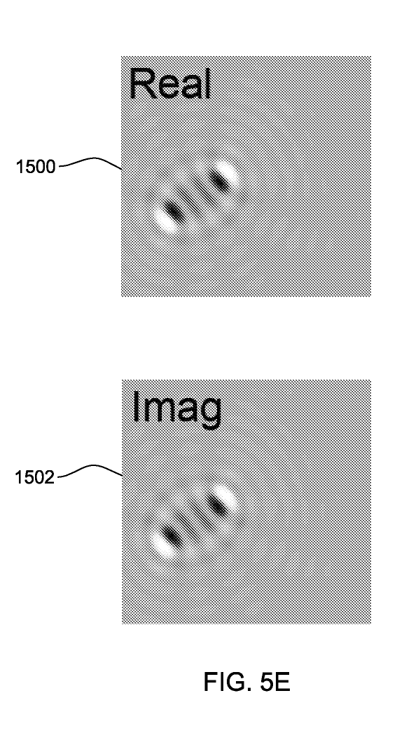

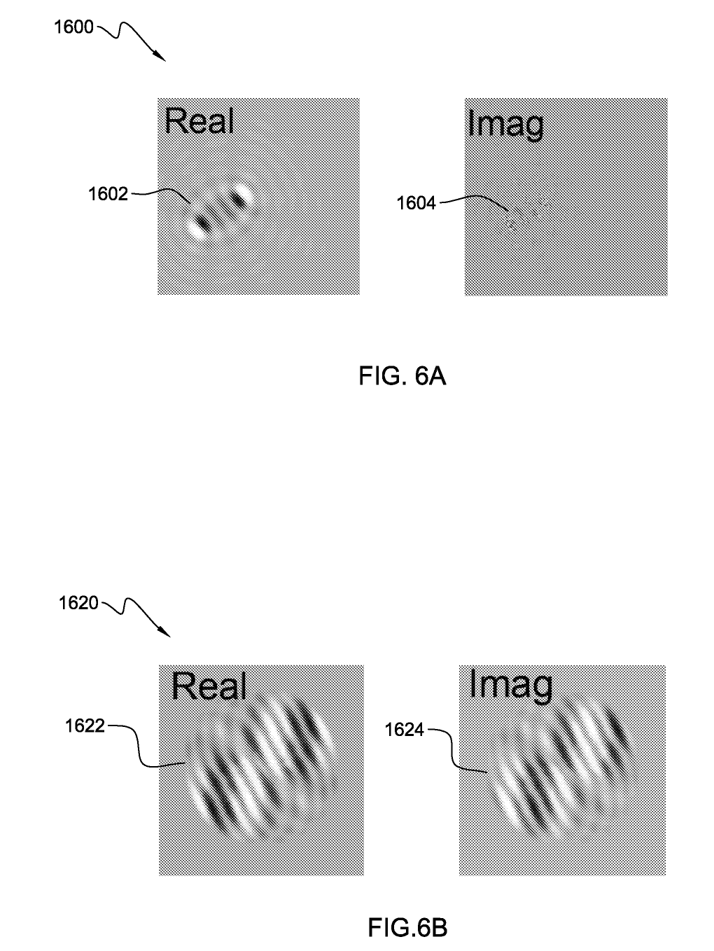

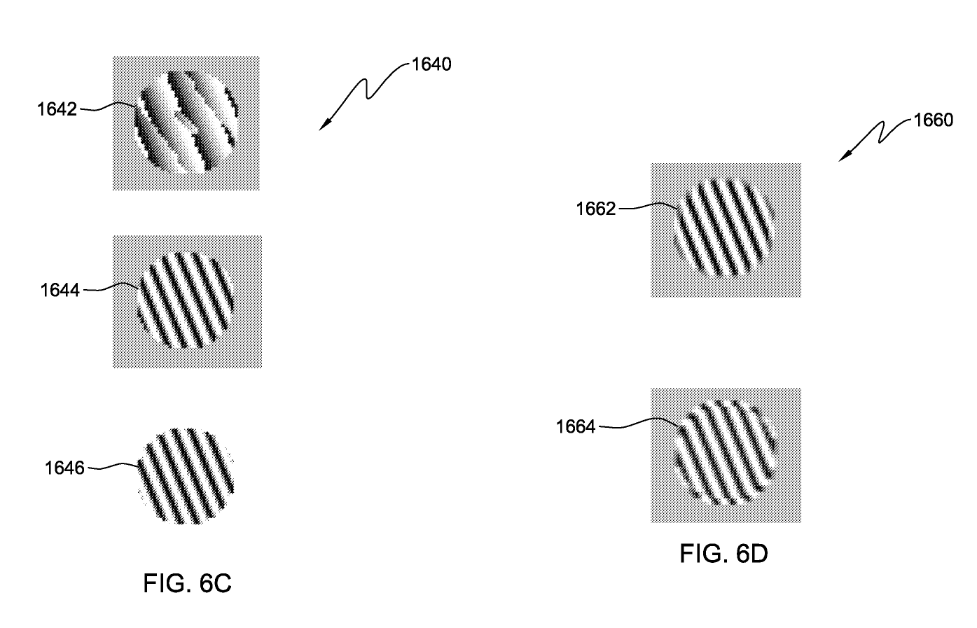

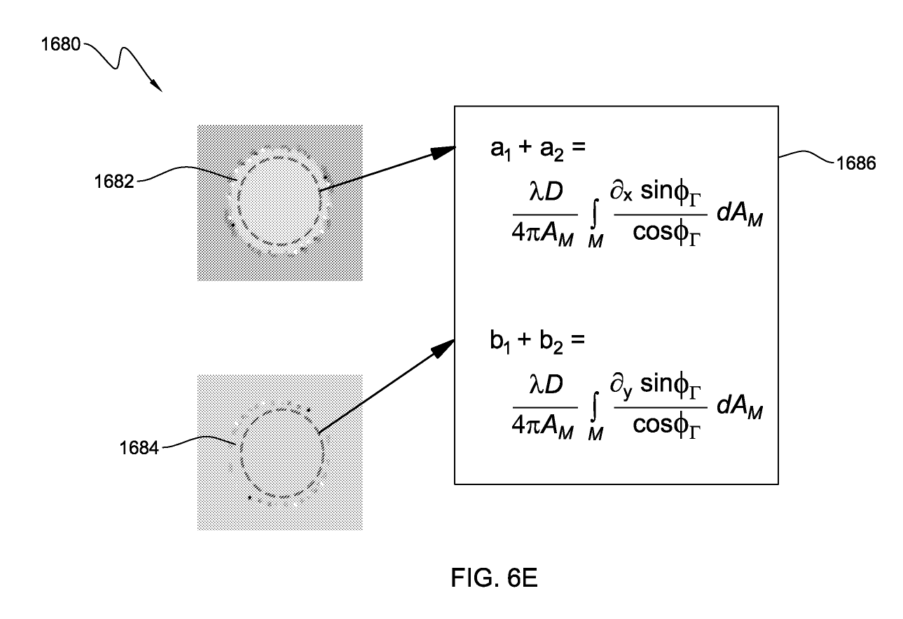

FIG. 4 shows an example of steps in direct solve image-based wave-front sensing 140 according to a preferred embodiment of the present invention. FIGS. 5A-E show corresponding pictorial examples of the steps in determining local piston differences and FIGS. 6A-E show corresponding pictorial examples of those steps in determining tip and tilt sums. Direct solve image-based wave-front sensing 140 is a closed loop solution that converges quickly after a relatively small number of iterations as opposed to other prior approaches.

Beginning in step 142 of FIG. 4A, the focal planes 122 collect an image, amplitude 1420 and phase 1422, from a single, white-light, in-focus, point spread function (PSF) for each pair of mirrors in the array 118. Typically, unselected mirrors are blocked (e.g., masked off or closed aperture) during testing of a selected pair. So, as reflected by the corresponding example of FIG. 5A, the amplitude or pupil component 1420 of the collected image includes an amplitude component 1420-1 and 1420-2 for each of the pair of mirrors (not shown), indexed 1 and 2 for convenience of discussion herein. Likewise the phase component 1422 includes a phase component 1422-1 and 1422-2 for each of the pair of mirrors. The respective image renderings combine in step 144 in an in-focus, white-light, sparse-aperture optical PSF of the region 1440 in FIG. 5B. If the mirrors are both properly aligned (i.e., the respective pistons are aligned and the mirror tip/tilt sums are correct), the PSF 1440 reflects a single spot. Since in this example the mirrors are not aligned, the PSF 1440 reflects two spots 1440-1 and 1440-2.

In step 146, the PSF 1440 is Fourier Transformed (FT) to extract real and imaginary optical transfer function (OTF) components (Re{OTF}) 1460, (Im{OTF}) 1462 in FIG. 5C. Each component 1460, 1462 includes a carrier component 1460c, 1462c and two identical sideband components 1460s, 1462s. The real component (Re{OTF}) 1460 and imaginary component (Im{OTF}) 1462 are passed to an extractor/shifter 148. The extractor/shifter 148 extracts the sidebands 1460s, 1462s and shifts the result to change the carrier frequency (OTF*), resulting in real and imaginary components (Re{OTF*}) 1480, (Im{OTF*}) 1482 in FIG. 5D. Inverse Fourier Transforming (FT⁻¹{ }) 150 the shifted components (Re{OTF*}) 1480, (Im{OTF*}) 1482 provides spatial images 1500, 1502 in FIG. 5E with the form: Ψ=2ghe^{ik(p1-p2)}.

The in-phase portion (φₚᵢₛₜ) of Ψ gives piston information as the difference for the two pistons is p₁−p₂. The 2gh term is tip/tilt information for the baseline pupils, where g is the Fourier Transform of one pupil and h is the Fourier Transform of the other and [g]²+[h]² contains a mix of all other baselines. In particular, the in-phase of the term may be determined 152 from the arctangent of the ratio of the imaginary to real components of Ψ, i.e., φₚᵢₛₜ={Im{Ψ}/Re{Ψ}}. Thus, the piston difference for two mirrors may be determined 154 from the arcsine of the sine of the in-phase of the term and has the form: p₁−p₂=λ/2π sin⁻¹[sin φₚᵢₛₜ].

Determining the tip/tilt sums begins by taking 160 the real component part of gh, 1600 in FIG. 6A, i.e., (Ψ/2)e^{-iφpist}εR, which has a real component 1602 and a discarded imaginary component 1604. Next, in step 162 the real component 1602 is Fourier Transformed (Γ=FT{(Ψ/2)e^{-iφpist}}) 1620, which provides real and imaginary components 1622, 1624 in FIG. 6B. In step 164, Γ provides (1640 in FIG. 6C) an image (Φ_{Γ}) 1642 and phase components (sin Φ_{Γ}) 1644, (cos Φ_{Γ}) 1646. Since mirror tip/tilt differences manifest as phase variations (i.e., a gradient) in step 166, 2D changes are extracted from the phase 1660 in FIG. 6D, i.e., changes in the x direction (d(sin Φ_{Γ})/dx) 1662 and the y direction (d(sin Φ_{Γ})/dy) 1664. In step 168, the extracted 2D changes are normalized 1680 in FIG. 6E, i.e., divided by cos Φ_{Γ}, providing tip/tilt components 1682, 1684. This eliminates sign ambiguities and/or phase unwrapping problems (from phase >, or multiple of, 2π) for a non-redundant aperture. The tip/tilt sums may be determined by integrating the normalized differences 1686 over the focal area, where a₁, a₂, b₁ and b₂ are tip/tilt values for the respective mirrors.

The values of a, b and p are extracted in step 170, e.g., using any suitable well-known curve fitting technique. In step 172 another pair of mirrors is selected until differences and sums have been selected and applied, when the result is compared with the preceding values. If the difference of the comparison is within an acceptable threshold value (δ), a solution has been found and direct solve ends in step 174. Otherwise, if the new values are not within δ of the old, in step 172 the new values are applied to the mirrors. Then, returning to step 144, the focal plane 122 collects amplitude 1420 and phase 1422 from a single white light with pair of mirrors in the array 118 adjusted according to the new values an another iteration begins.

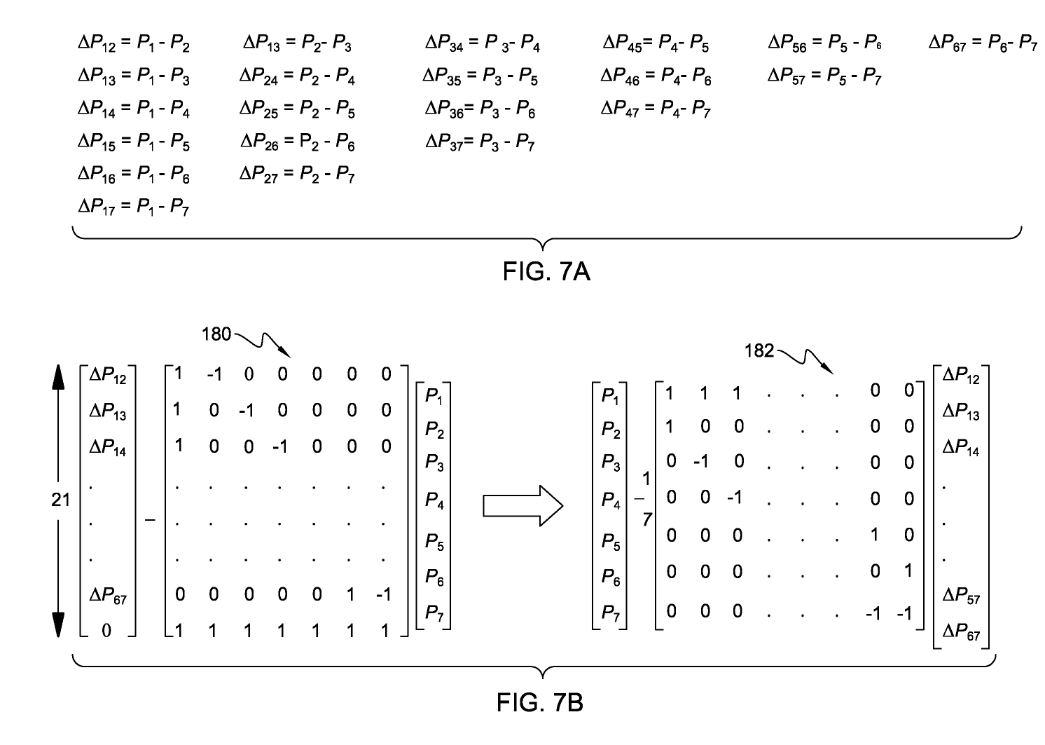

FIG. 7A shows an example of constrained linear equations for converting piston differences (Δpᵢⱼ) to mirror pistons (pᵢ, pⱼ) for mirrors i and j. These equations are subject to the constraint that the sum of the n pistons is zero, where n is the number of mirrors, i.e.,

$${\sum }_{j = 1}^{n} {p}_{j} = 0.$$

By introducing arbitrary biases to maintain this constraint, the set of piston motions remain in the center of the actuator range.

FIG. 7B shows the constrained piston differences expressed in matrix formalism 180 to yield a solution 182 that, using a simple sparse matrix multiply, converts from the direct solve phase retrieval piston differences (P₁, P₂) to actual mirror piston locations. The tip/tilt sums may be similarly determined with the incorporation of a rotation matrix for the de-rotations from the different baseline vector directions. Ultimately, however, this yields a simple matrix multiplication for tip/tilt sum determination as well.

Advantageously, direct solve sensing provides a simple image-based wave-front sensing approach that, unlike other approaches, uses a single in-focus white-light image to solve directly for piston differences and tip/tilt sums. Focus and/or wavelength dithering is unnecessary to consistently and quickly (˜0.01 seconds) arrive at a solution in a minimal number of floating point operations on a simple, single process computer. Further, direct solve avoids sign ambiguities and/or phase unwrapping problems for a non-redundant aperture that are otherwise encountered. Finally, because of its simplicity, any state of the art onboard computer may implement direct solve for space based wave-front sensing and control.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A method of aligning an array of mirrors in a sparse aperture telescope system, said method comprising the steps of:
a) projecting an image onto mirrors in an array of mirrors;
b) collecting a point spread function (PSF) from a first pair of said mirrors;
c) extracting a spatial image from PSF sidebands;
d) determining a difference for said first pair of mirrors; and
e) determining a tip and tilt for said first pair of mirrors.

2. A method as in claim 1, further comprising selecting another pair of said mirrors and returning to step (a) and repeating until said difference and said tip and tilt are determined for all said mirrors in said array.

3. A method as in claim 2, further comprising applying the determined said difference and said tip and tilt and selectively returning to step (a) and repeating.

4. A method as in claim 3, wherein applying the determined said difference and said tip and tilt further comprises checking whether the current said difference and said tip and tilt matches the determined said difference and said tip and tilt to within a selected threshold value and returning to step (a) and repeating until a match is found.

5. A method as in claim 1, wherein said difference is the piston difference (p₁−p₂) of said first pair and said tip and tilt are sums (a₁−a₂, b₁−b₂) of tip and tilt of said first pair.

6. A method as in claim 5, wherein the step (c) of extracting said spatial image comprises the steps of:
i) determining the Fourier Transform of said PSF (FT{PSF});
ii) extracting sidebands from said Fourier Transform and shifting said sidebands to a selected carrier frequency (OTF*); and
iii) determining the Fourier Transform of said shifted sidebands (FT⁻¹ {OTF}).

7. A method as in claim 6, wherein said spatial image has a piston component having the form φₚᵢₛₜ={Im{Ψ}/Re{Ψ}}, Ψ2ghe^{ik(p1-p2)}, and 2gh term is tip/tilt information for the baseline pupils.

8. A method as in claim 7, wherein the piston differences are constrained by
$${\sum }_{j = 1}^{n} {p}_{j} = 0.$$

9. A method as in claim 7, wherein the step (d) of determining the difference comprises the steps of:
i) discarding the imaginary component of gh ((Ψ/2)e^{-iφpist}εR);
ii) determining the Fourier Transform of said gh (Γ=FT{(Ψ/2)e^{-iφpist}});
iii) extracting an image gradient from the real portion Fourier Transform; and
iv) normalizing the extracted gradient.

10. A method as in claim 9, wherein extracting said image gradient in step (d)(iii) comprises extracting 2D changes in the x direction (d(sin Φ_{Γ})/dx) 1662 and the y direction (d(sin Φ_{Γ})/dy).

11. A method as in claim 10, wherein normalizing in step (d)(vi) comprises dividing the gradient by cos Φ_{Γ}.

12. A computer program product for aligning an array of mirrors, said computer program product comprising a computer usable medium having computer readable program code stored thereon comprising:
computer readable program code means for projecting an image onto mirrors in an array of mirrors;
computer readable program code means for collecting a point spread function (PSF) from pairs of said mirrors;
computer readable program code means for extracting a spatial image from PSF sidebands;
computer readable program code means for determining a difference for said pairs of mirrors; and
computer readable program code means for determining a tip and tilt for said pairs of mirrors.

13. A computer program product for aligning an array of mirrors as in claim 12, further comprising computer readable program code means for applying the determined said difference and said tip and tilt to respective said mirrors.

14. A computer program product for aligning an array of mirrors as in claim 13, wherein the computer readable program code means for applying the determined said difference and said tip and tilt further comprises computer readable program code means for checking whether the current said difference and said tip and tilt matches the determined said difference and said tip and tilt to within a selected threshold value.

15. A computer program product for aligning an array of mirrors as in claim 12, wherein said difference is the piston difference (p₁−p₂) of said first pair and said tip and tilt are sums (a₁−a₂, b₁−b₂) of tip and tilt of said first pair, wherein the piston differences are constrained by
$${\sum }_{j = 1}^{n} {p}_{j} = 0.$$

16. A computer program product for aligning an array of mirrors as in claim 15, wherein the computer readable program code means for extracting said spatial image comprises the steps of:
computer readable program code means for determining the Fourier Transform of said PSF (FT{PSF});
computer readable program code means for extracting sidebands from said Fourier Transform and shifting said sidebands to a selected carrier frequency (OTF*); and
computer readable program code means for determining the Fourier Transform of said shifted sidebands (FT⁻¹{OTF}).

17. A computer program product for aligning an array of mirrors as in claim 16, wherein said spatial image has a piston component having the form φₚᵢₛₜ={Im{Ψ}/Re{Ψ}}, Ψ=2ghe^{ik(p1-p2)}, and 2gh term is tip/tilt information for the baseline pupils.

18. A computer program product for aligning an array of mirrors as in claim 17, wherein the computer readable program code means for determining the difference comprises the steps of:
computer readable program code means for discarding the imaginary component of gh ((Ψ/2)e^{-iφpist}εR);
computer readable program code means for determining the Fourier Transform of said gh (Γ=FT{(Ψ/2)e^{-iφpist}});
computer readable program code means for extracting an image gradient from the real portion Fourier Transform; and
computer readable program code means for normalizing the extracted gradient.

19. A computer program product for aligning an array of mirrors as in claim 18, wherein the computer readable program code means for extracting said image gradient comprises computer readable program code means for extracting 2D changes in the x direction (d(sin Φ_{Γ})/dx) 1662 and the y direction (d(sin Φ_{Γ})/dy).

20. A computer program product for aligning an array of mirrors as in claim 19, wherein the computer readable program code means for normalizing comprises computer readable program code means for dividing the gradient by cos Φ_{Γ}.
